(19) United States
(12) Patent Application Publication
(10) Pub. No.: US 2023/0184461 A1
(43) Pub. Date: Jun. 15, 2023

(54) HEATING DEVICE FOR HEATING A GAS STREAM

(71) Applicant: Friedrich Boysen GmbH & Co. KG, Altensteig (DE)

(72) Inventors: Volkmar KNIPPS, Haiterbach (DE); Stefan MÜLLER, Horb-Ihlingen (DE); Ramazan SAHAN, Bösingen (DE); Falko SCHUBE, Altensteig (DE)

(21) Appl. No.: 18/073,375

(22) Filed: Dec. 1, 2022

(30) Foreign Application Priority Data
Dec. 15, 2021 (DE) 10 2021 133 353.9
Jul. 5, 2022 (DE) 10 2022 116 755.0

(51) Int. Cl. F24H 3/00; H05B 3/32; B01D 53/94; F01N 3/20; F01N 3/28

(52) U.S. Cl. CPC F24H 3/002; H05B 3/32; B01D 53/94; F01N 3/2026; F01N 3/2842; F01N 3/2825; F01N 3/2807; H05B 2203/022

(57) ABSTRACT

The present invention relates to a heating device for heating a gas flow, in particular an exhaust gas flow of an internal combustion engine, said heating device comprising an electrically conductive heating element that can be flowed through by the gas flow in an axial direction and that has at least two heating segments that are sectionally separated from one another by a gap that is in particular open at one side; a carrier device having at least one electrically insulating carrier element that at least sectionally surrounds the heating element in a peripheral direction and/or at least sectionally covers a marginal region of at least one axial end face of the heating element, wherein the carrier element has at least one spacer section that projects into the gap; and a housing section in which the heating element and the carrier device are held.

The invention relates to a heating device for heating a gas flow, in particular an exhaust gas flow of an internal combustion engine.

In many applications, it is necessary to heat a gas flow, for example, to create certain reaction conditions in said gas flow. One important application is exhaust gas technology where the focus is increasingly on as efficient as possible an exhaust gas aftertreatment. Various catalytic converters that are used in this respect can only be efficiently operated in a certain temperature window that is considerably above the typical environmental temperature. On a cold start of an internal combustion engine, its exhaust gases, which are initially comparatively cold, impact a catalytic converter body that is likewise comparatively cool so that the lower threshold temperature of the temperature window referred to is often not reached. This has the result that the exhaust gases are not cleaned as completely as is desired. Only with an increasing heating of the exhaust gases, and the associated heating of the catalytic converter body, does the system enter the temperature range in which the desired catalytic reactions take place efficiently.

One measure for improving the cold-start behavior of a corresponding exhaust gas system comprises providing a heating device, by means of which the onflowing exhaust gas is heated, upstream of the catalytic converter body. In other words, heat is additionally added to the exhaust gas flow to bring the system as quickly as possible to a working temperature at which an efficient exhaust gas aftertreatment is ensured.

Such a heating device can comprise an electrically heatable disk that has channels through which the exhaust gas flow flows before it is fed to the catalytic converter body. In this respect, a heat transfer from the heated disk to the gas flow occurs. This gas flow in turn heats the catalytic converter body to bring it to the working temperature mentioned as quickly as possible.

Such disks are electrically conductive and—viewed in the gas flow direction—generally have a meandering structure comprising—in simple terms—segments arranged in serpentine lines so that as long as possible a heating path is produced between electrical contacts of the disk, said heating path heating up quickly during a current feed due to its ohmic resistance. In addition to the cross-section, the length of the current-carrying path is decisive for the resistance and thus for the heating power of the disk—for a given material.

The integration of such a heating device into an exhaust gas system is not without problems since the disk that can have a current fed to it has to be reliably electrically insulated. In addition, it has to be ensured that an unintentional short circuit between the individual segments of the disk is also avoided during the operation of the exhaust gas system. Furthermore, the heating device has to be robust and has to be able to withstand vibration loads and a high thermal stress. This also applies to heating devices of the kind described above that are used in other areas.

Previously known heating devices are often not sufficiently reliable and/or have a complex design so that there is a need for an improved solution that is simultaneously reliable and simple in design.

This object is satisfied by a heating device having the features of claim 1.

The heating device in accordance with the invention comprises an electrically conductive heating element that can be flowed through by the gas flow in an axial direction and that has at least two heating segments that are sectionally separated from one another by a gap that is in particular open at one side. In this respect, the segments themselves can preferably be flowed through by gas. In other words, the entire gas flow does not flow through the at least one gap during operation, but also flows through the segments. For this purpose, the heating segments can have channels whose walls enable an efficient transfer of heat from the conductive material of the heating element to the gas.

Furthermore, a carrier device is provided having at least one electrically insulating carrier element that at least sectionally surrounds the heating element in a peripheral direction and/or at least sectionally covers a marginal region of at least one axial end face of the heating element, wherein the carrier element has at least one spacer section that projects into the gap.

The heating segments are electrically connected to one another. However, the spacer section is dimensioned such that it reliably separates the mutually oppositely disposed sides of the heating segments, which bound the gap, from one another so that an unwanted electrical short circuit due to vibrations and/or a thermal expansion in regions of the heating segments that are not provided is reliably prevented. It is not necessary that the entire gap is filled by the spacer section. It can by all means be sufficient to provide a comparatively small spacer section that in particular projects into an end section of the gap. The sides of the heating segments preferably already contact the spacer section in a cold state of the heating device.

Furthermore, the heating device in accordance with the invention has a housing section in which the heating element and the carrier device are held. The carrier device in particular electrically insulates the housing section with respect to the heating element.

The housing section is inter alia used to secure the ensemble of the heating element and the carrier device so that the functionality of the heating device is also reliably ensured in the event of a thermal and/or mechanical load on the heating device. Furthermore, the housing section facilitates the assembly of the heating device in a gas-conducting system. With a suitable design, the heating device can also be pre-assembled so that it can be installed as a whole in a system.

Further embodiments of the invention are set forth in the description, in the claims, and in the enclosed drawings.

In accordance with an embodiment, the spacer section extends in the axial direction and/or in a direction perpendicular to the axial direction from the carrier element into the gap.

The carrier element can be of a ring-like design or can have a basic shape of a circular segment. For example, the carrier element is a ring or a ring section that is applied to one of the end faces of the heating element if it has a circular contour. It is understood that the heating element can also assume other shapes (e.g. oval, rectangular, polygonal). The carrier element then has a complementary design. Provision can also be made that the carrier element is applied to the peripheral surface of the heating element. In this case, the shapes of the heating element and the carrier element are also complementary. The two concepts described above can be combined.

In accordance with a further embodiment, the carrier device is formed in multiple pieces. For example, the carrier device comprises a first carrier element and a second carrier element that each surround at least a part of the periphery of the heating element and/or that each cover at least a part of a marginal region of at least one end face of the heating element. It is, for example, conceivable that the first carrier element and the second carrier element are each ring-shaped and each cover an outer marginal region of the two end faces.

It is also conceivable to provide a plurality of carrier elements that each have only one spacer section. A section at least sectionally covering the marginal region of at least one axial end face of the heating element and/or a section of such carrier elements that at least sectionally surrounds the heating element in the peripheral direction can be of a comparatively short design. Carrier elements of the same design or of different designs or of the same or different dimensions can be combined to form a carrier device that is suitable for the respective application.

Cost savings in terms of manufacture and assembly result when the first carrier element and the second carrier element are identical parts.

A further measure for improving the fixing of the heating element comprises supporting the heating element at the housing section via at least one bearing mat. A support preferably takes place in an axial direction, in particular in both axial directions (e.g. by a separate bearing mat or a common bearing mat), so that the heating element can be secured in a substantially axially fixed manner, but at the same time vibrations and/or thermal expansions can also be absorbed, compensated, and/or damped. The above statements apply in an analogous manner to the carrier device. The carrier device can likewise be supported at the housing section, in particular in the axial direction, via at least one bearing mat.

Fibrous mats, for example composed of a polycrystalline material, are in particular suitable as bearing mats.

The support concepts described above by means of bearing mats can also be combined. For example, one end face of the heating element is only in contact with the housing section via a bearing mat, while the other end face of the heating element contacts the carrier device that is in turn axially supported at the housing section via a bearing mat.

To be able to absorb a thermal expansion of the heating element, a clearance can exist between the carrier device and/or the heating element, on the one hand, and the housing section, on the other hand, in a radial direction at least in a cold state of the heating element. For example, the clearance is provided by a radial gap that is only filled with air or with a bearing mat that is not compressed or only slightly compressed.

As was already initially mentioned, the heating segments of the heating element are preferably gas-permeable. A honeycomb basic structure of the heating element having a large number of gas-conducting channels enables an efficient heat transfer and generates comparatively little counter pressure.

The heating element in particular has a plurality of gaps that are preferably arranged in parallel and/or that project in a direction in parallel with an end face of the heating element, alternately from mutually oppositely disposed sides of the heating element, into the interior of the heating element. The gaps are open at one side in this respect. A meandering structure with a long heating path is thereby produced. The area of the gaps is substantially smaller than that of the heating segments in a plan view of the side of the heating element flowed on by the gas flow. The lion's share of the gas flow thus flows through the heating segments where a particularly efficient heat transfer takes place.

An axial securing of the heating element in which the housing section has at least one axial shoulder, at which the heating element is—indirectly or directly—supported in the axial direction, is easy to implement in terms of design.

The housing section can be formed in multiple parts. For example, the housing section comprises a first housing element and a second housing element between which the carrier device is held with the heating element.

The first housing element and/or the second housing element and/or the carrier device and/or the first carrier element and/or the second carrier element can be L-shaped in a cross-section. Such components can be produced in a simple manner.

The heating device can be integrated into a gas-conducting system with little effort when the first housing element and/or the second housing element has/have a connection section by means of which the housing section can be connected to further gas-conducting components.

A compact and easy-to-assemble embodiment provides that the first housing element is plugged into the second housing element.

Provision can be made that the first housing element and/or the second housing element is/are sheet metal components. A suitable material for this purpose is stainless steel, for example. The first housing element and/or the second housing element can also be cast parts.

The first housing element and/or the second housing element can comprise a ring section having at least one tab section extending in the axial direction. The tab sections of the two housing elements can overlap in an assembled state or can be connected end-to-end to one another.

For the purpose of supplying the heating element with electrical energy, the housing section can have a first and a second contact opening through which the heating element is electrically contactable. Corresponding connectors are connected to a control device for operating the heating device. They can in turn be connected to a control unit of the motor or can be integrated therein. In embodiments of the housing parts with tab sections, such contact openings are dispensable in many cases since the heating element is accessible through cutouts arranged between the tab sections. For given housing parts having a plurality of (possibly equally distributed) cutouts, great flexibility is therefore achieved with respect to the geometry of the establishing of a contact with the heating element. The number and/or geometry of the tab sections and/or of the cutouts can be selected as required.

It very generally applies that the housing sections can be connected to one another in any desired manner, for example, by welding. A force-fitting connection (e.g. a plug-in connection) is also conceivable.

The housing section can be held by an outer housing that surrounds the housing section in a radial direction. The outer housing can be a tubular section of a component of an exhaust gas system. The outer housing can also comprise a first outer housing element and a second outer housing element, in particular wherein the first outer housing element and the second outer housing element are sheet metal components. The first outer housing element and the second outer housing element can, for example, be housing shells.

In this embodiment, it is, for example, possible for the heating element to be pre-assembled together with the carrier device in the housing section. The outer housing is then assembled and the total “package” is installed in an exhaust gas system.

The housing section can be connected, e.g. welded or stapled, to the outer housing at points, in sections, or along a substantially continuous connection line.

The carrier element is preferably at least sectionally produced, in particular completely produced, from corundum (Al₂O₃) and/or an electrically insulating ceramic material or a technical ceramic material. A glass ceramic material or materials including mica can also be suitable. The heating element is preferably at least sectionally produced, in particular completely produced, from a metallic material and/or at least sectionally has a metallic coating.

The present invention further relates to an exhaust gas treatment device comprising an inlet and an outlet and at least one exhaust gas treatment unit for treating an exhaust gas flow, in particular a catalytic converter unit or a filter unit, wherein a heating device in accordance with at least one of the embodiments described above is arranged between the inlet and the exhaust gas treatment unit, in particular directly in the flow direction of the exhaust gas upstream of the exhaust gas treatment unit.

The exhaust gas treatment device can have a single-piece housing component that receives the exhaust gas treatment unit and the heating device.

Alternatively, the housing section of the heating device forms a part of a housing of the exhaust gas treatment device, in particular wherein the inlet of the exhaust gas treatment device is connected to a component of the housing section.

The present invention furthermore relates to an exhaust gas system of an internal combustion engine comprising an exhaust gas treatment device in accordance with at least one of the embodiments described above.

The present invention will be explained in the following purely by way of example with reference to advantageous embodiments and to the enclosed drawings. There are shown:

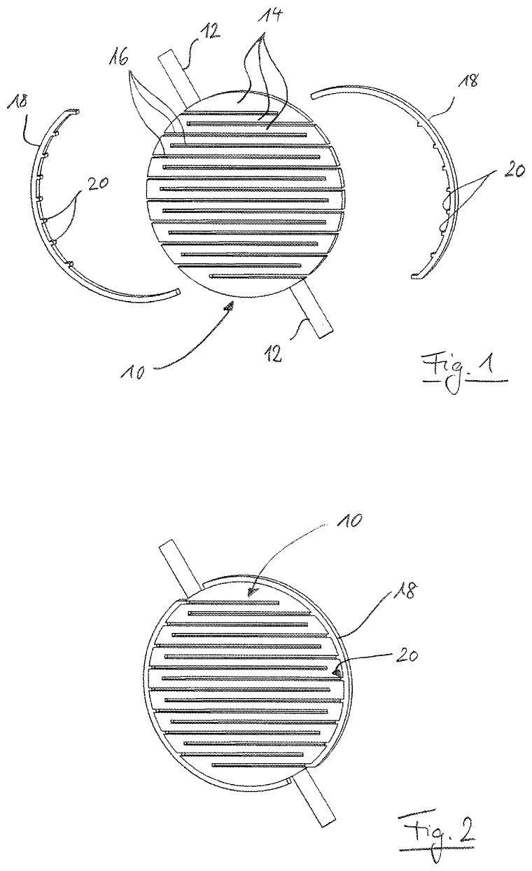

FIGS. 1 and 2 a first embodiment of the heating element and the carrier device;

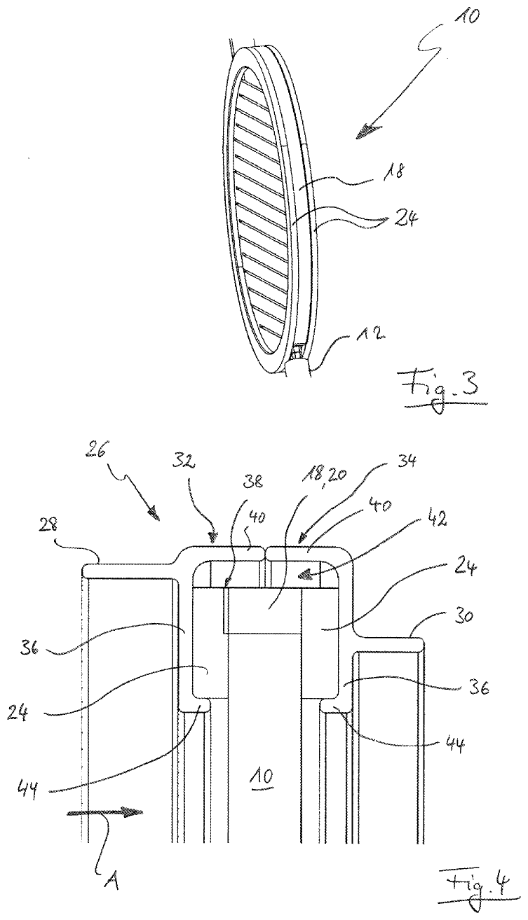

FIG. 3 the embodiments of FIGS. 1 and 2 that were provided with ring-shaped bearing mats;

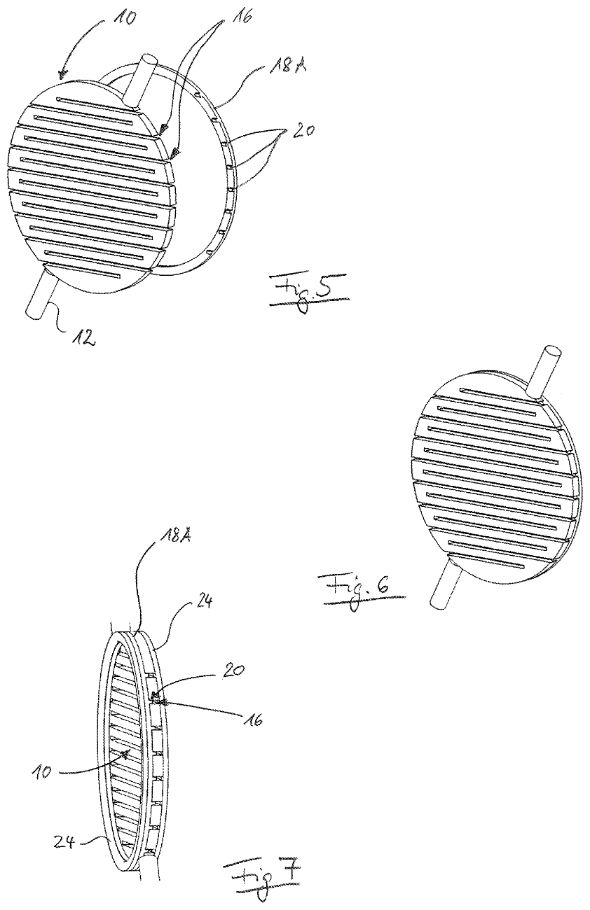

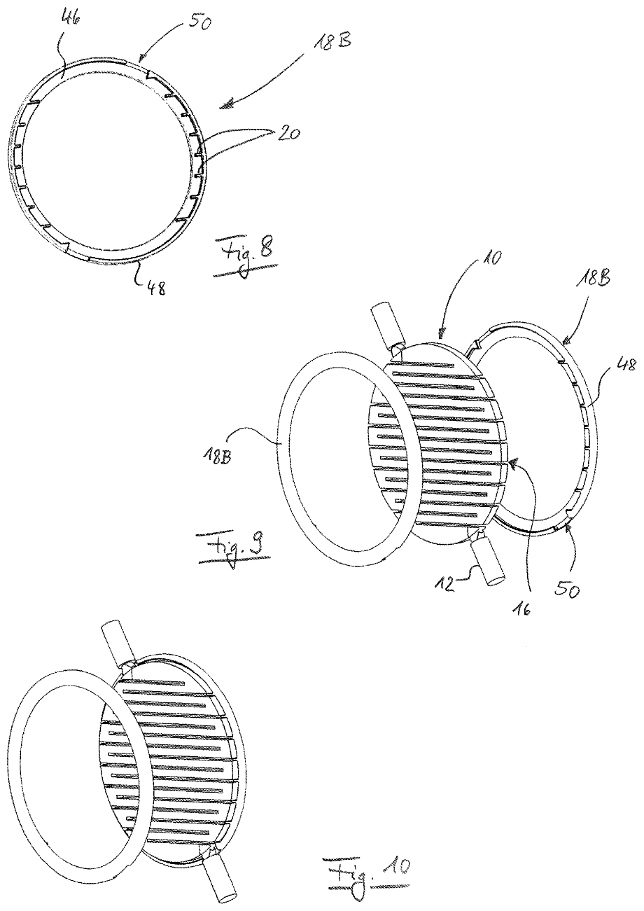

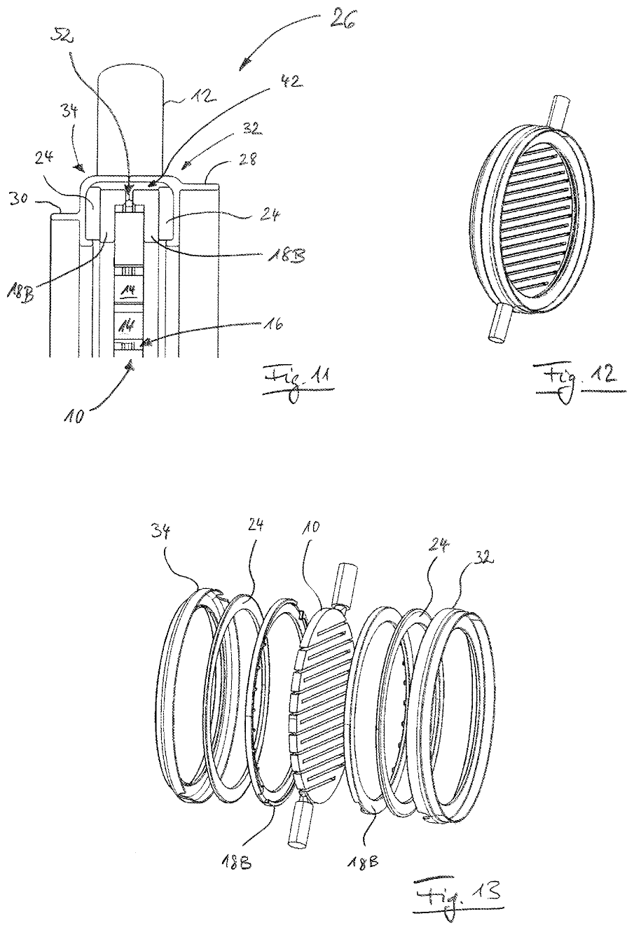

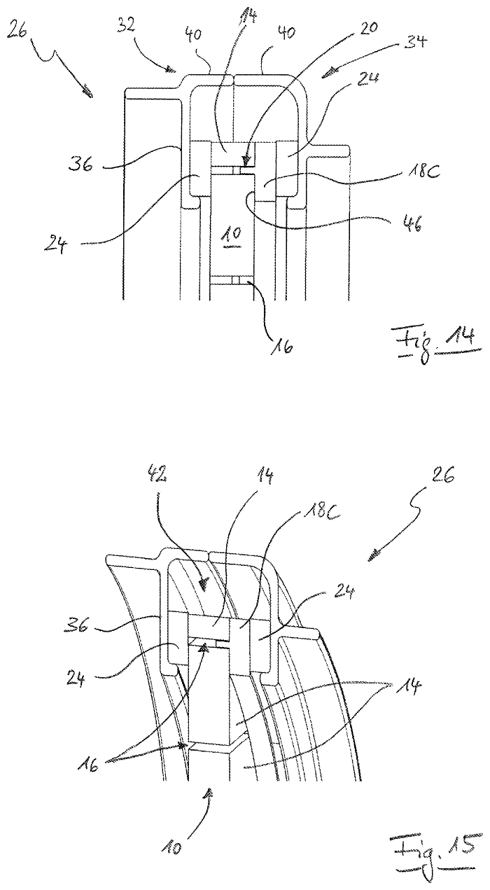

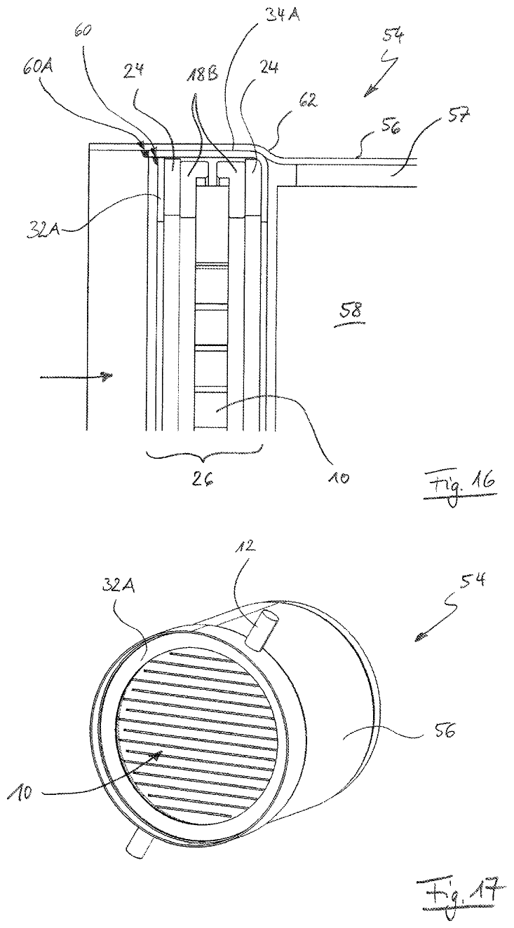

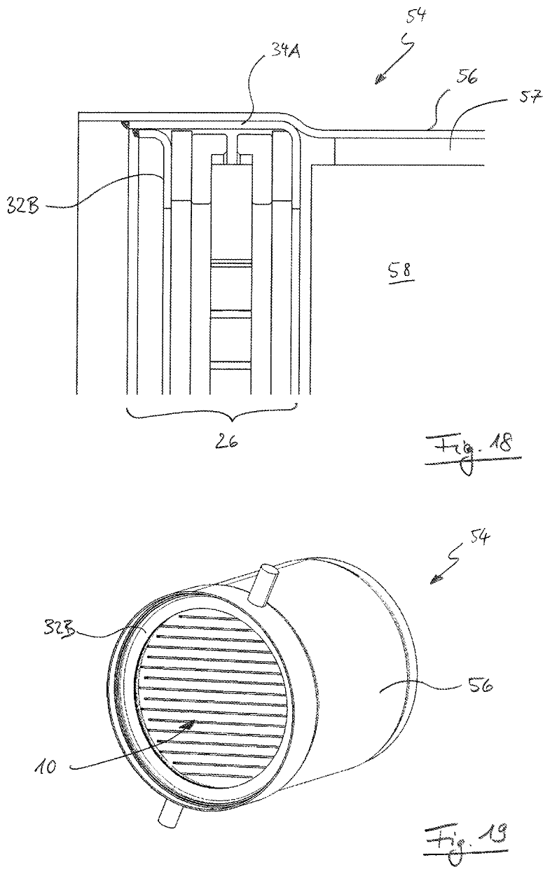

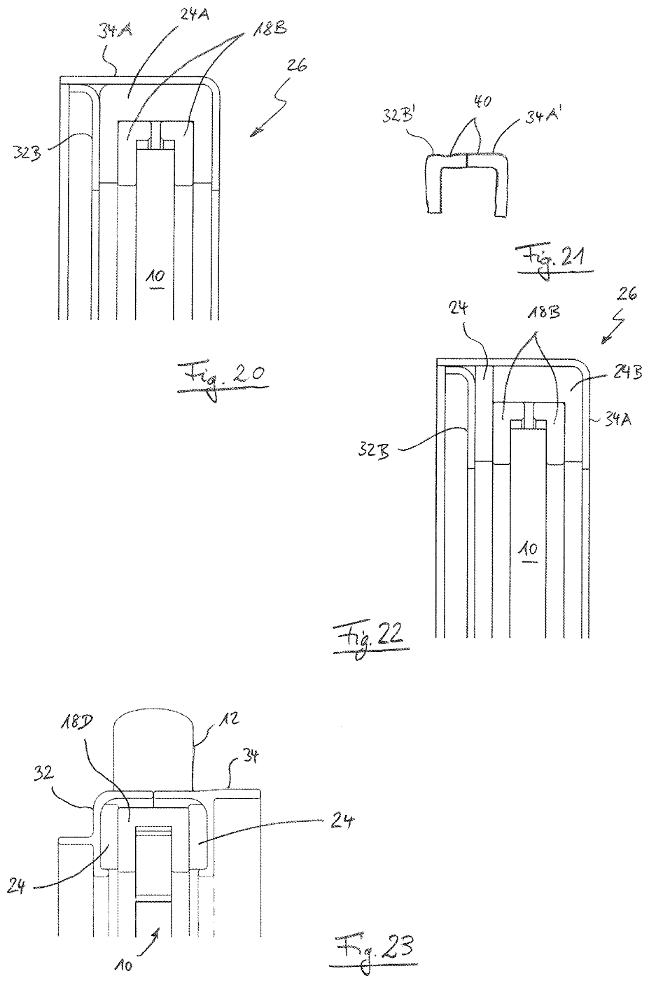

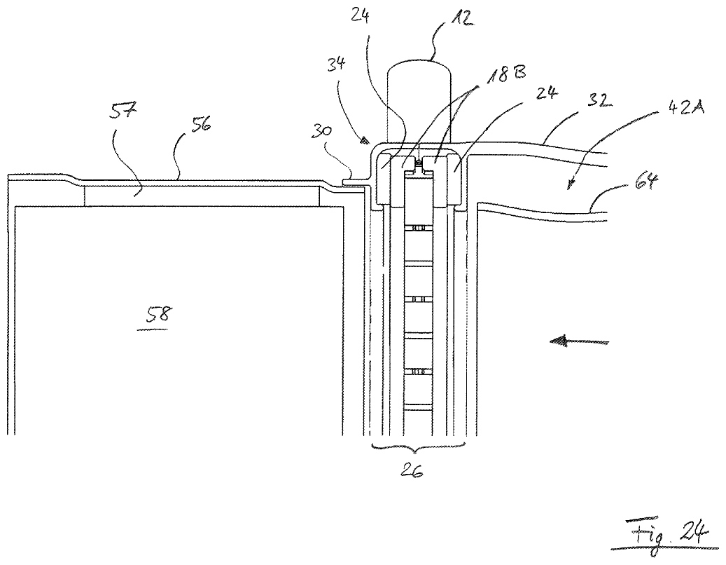

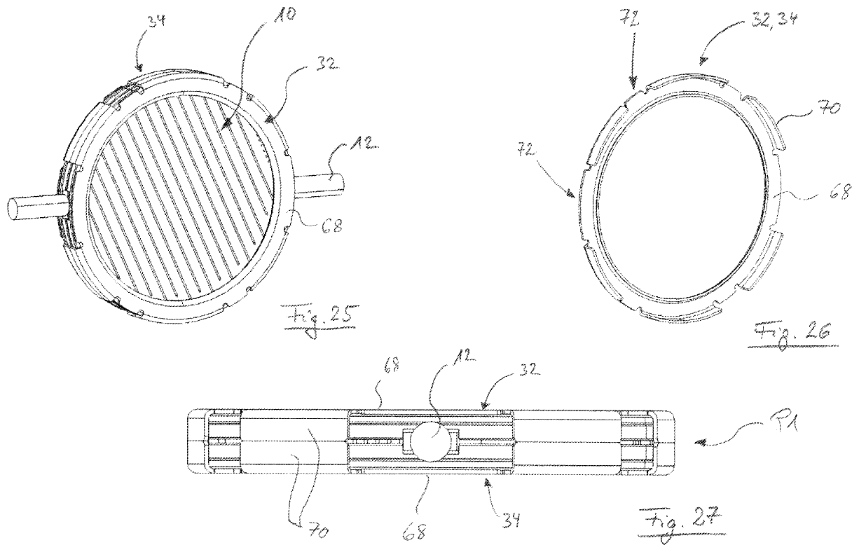

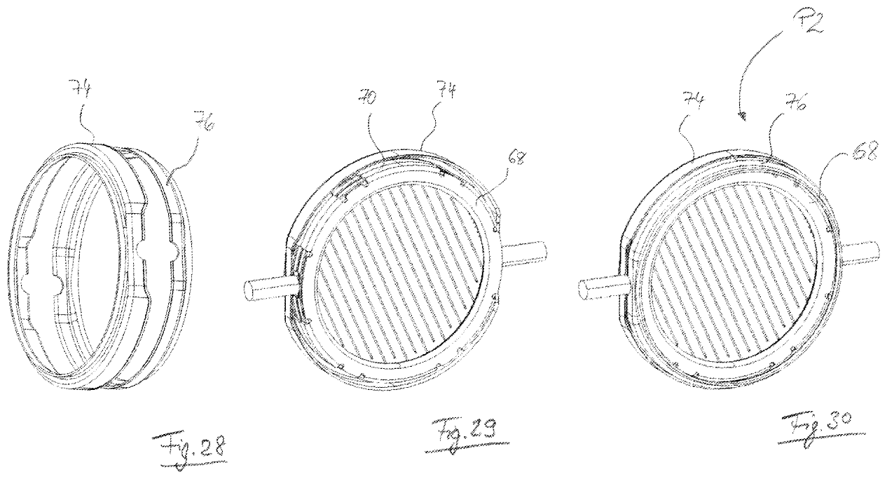

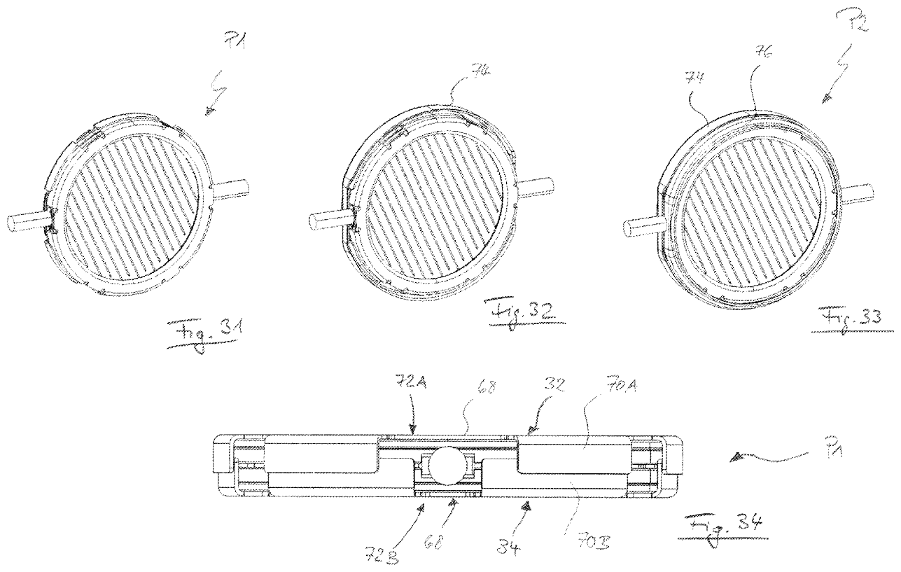

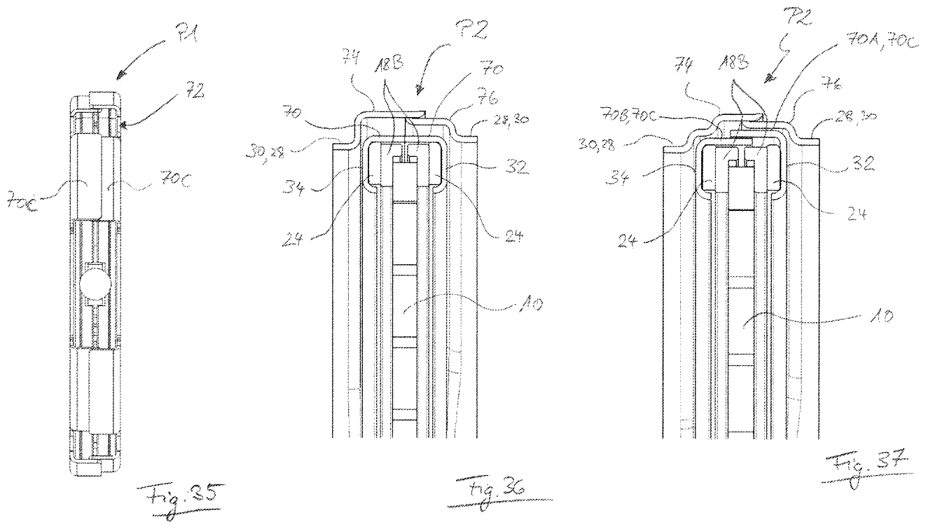

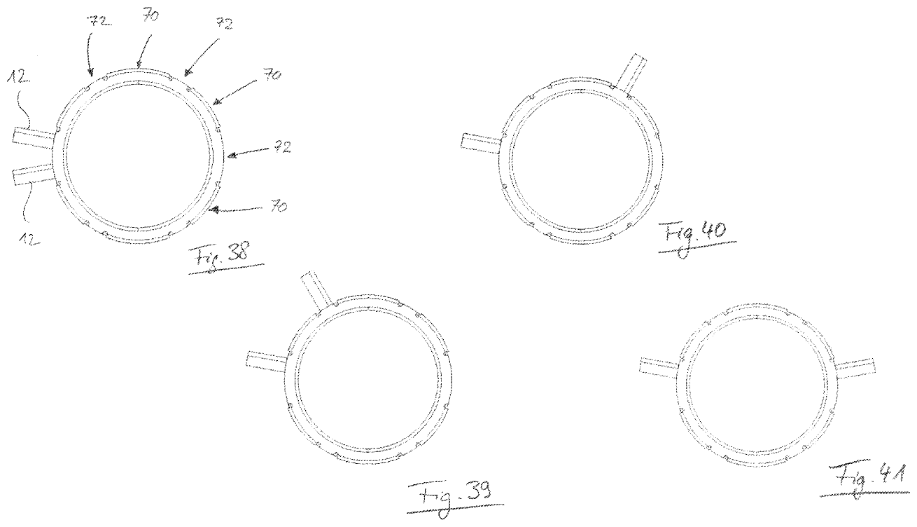

FIG. 4 a first embodiment of the heating device in accordance with the invention;

FIGS. 5 and 6 a second embodiment of the heating element and the carrier device;

FIG. 7 the embodiments of FIGS. 5 and 6 that were provided with ring-shaped bearing mats;

FIGS. 8 to 10 a third embodiment of the heating element and the carrier device;

FIGS. 11 to 13 a second embodiment of the heating device in accordance with the invention in a sectional view, in a perspective view, and in an exploded representation;

FIGS. 14 and 15 a third embodiment of the heating device in accordance with the invention in a sectional view and in a perspective sectional view, respectively;

FIGS. 16 and 17 a part of an embodiment of an exhaust gas treatment device in a sectional view and in a perspective view, respectively;

FIGS. 18 and 19 a part of a further embodiment of an exhaust gas treatment device in a sectional view and in a perspective view, respectively;

FIGS. 20 to 23 further embodiments of the heating device in accordance with the invention (in a sectional view in each case);

FIG. 24 a part of even a further embodiment of an exhaust gas treatment device in a sectional view;

FIGS. 25 to 27 a first embodiment of the housing parts with tab sections in different views;

FIGS. 28 to 30 an embodiment of an outer housing in different views;

FIGS. 31 to 34 a second embodiment of the housing parts with tab sections in different views;

FIG. 35 a third embodiment of the housing parts with tab sections;

FIGS. 36 and 37 further embodiments of the heating device in accordance with the invention (in a sectional view in each case);

FIGS. 38 to 41 exemplary variation possibilities of the connection geometry; and

FIGS. 42 to 45 further embodiments of the carrier device with a plurality of carrier elements in each case.

FIG. 1 shows a heating disk 10 that is of a circular design in an axial view in the present embodiment. In general, the outer contour and the axial thickness of the heating disk 10 are freely selectable and can be adapted to the respective present requirements.

The heating disk 10 at least partly consists of an electrically conductive material and/or is at least partly coated with such a material so that it is heated during a current feed by means of electrical connectors 12 (resistance heating). To form a suitably high electrical resistance of the heating disk 10, the heating disk 10 has gaps 16 that extend in parallel and that sectionally separate individual heating segments 14 from one another. The gaps 16 are alternately open at the sides (in FIG. 1, alternately at the right and left margins of the disk 10). Figuratively speaking, a meandering or serpentine structure is hereby produced.

The heating segments 14 do not represent an impenetrable flow resistance, but rather have a plurality of fine axial channels (not shown) through which a gas flow axially flowing onto an end face of the heating disk 10 can pass. It has proved particularly suitable if the heating segments 14 have a honeycomb basic structure. Such a basic structure has a high number of channels and therefore provides a large surface that promotes the heat exchange between the heating disk 10 and the gas flow.

During the operation of the heating disk 10, said heating disk 10 expands due to thermal effects, which can have the result that adjacent heating segments 14 contact one another in regions that are not provided and an electrical short circuit is hereby generated. Mechanical loads and vibrations, such as, for example, typically occur on a use in a motor vehicle, can bring about similar problems.

This is remedied in that the heating disk 10 is supported by a carrier device that comprises two separate carrier elements 18 in the example shown. The carrier elements 18 are circular segments of the same kind (identical parts) that are adapted to the geometry of the outer contour of the heating disk 10. They each have spacers 20 at their concave inner sides, said spacers 20 being formed in a complementary manner to the gap openings respectively associated with them. When the carrier elements 18 are assembled at the heating disk 10 (see FIG. 2), the spacers 20 project into the open ends of the gaps 16. It is thereby ensured that adjacent heating segments 14 also remain reliably spaced apart from one another in the event of vibrations/repeated load and/or a thermal expansion. Furthermore, the carrier elements 18 almost completely surround the heating disk 10 in the peripheral direction. Gaps are only provided in the region of the connectors 12.

Due to the almost complete enclosure of the heating disk 10 by the carrier elements 18, said heating disk 10 is also insulated in the radial direction. In deviation from the embodiment shown, the carrier elements 18 can (sectionally) have a greater axial thickness than the heating disk 10 to also be able to function as spacers in the axial direction.

To achieve a good electrical insulation, the carrier elements 18 are composed of corundum, a glass ceramic material, mica, and/or a ceramic material.

FIG. 3 shows a perspective view of the embodiment in accordance with FIGS. 1 and 2, wherein ring-shaped bearing mats 24 have been applied to the end faces of the carrier elements 18. The bearing mats 24 cover marginal regions of the end faces of the heating disk 10.

FIG. 4 shows a heating device 26 in a sectional view in which the components described with reference to FIGS. 1, 2, and 3 have been installed. The heating device 26 has an inlet 28 and an outlet 30. The exhaust gas flows in the axial direction A through the inlet 28 into the heating device 26 and impacts an inlet-side end face of the heating disk 10. The gas flow flows through the heating disk 10 in the manner described above and exits the heating disk 10 at its outlet-side end face before it flows out of the heating device 26 through the outlet 30. In general, it is equally possible for the gas flow to flow through the heating device 26 in the opposite direction.

The inlet 28 and the outlet 30 can be connected to further gas-conducting components, for example, to an inlet funnel, not shown, or to a housing component that surrounds an exhaust gas purification component such as a catalytic converter. Said components can be plugged into or plugged onto the inlet 28 and/or the outlet 30. A welded connection or another type of connection is then established to connect the components and the heating device 26 to one another in a gas-tight manner.

The construction shown in FIG. 4 is arranged and axially secured between two housing parts 32, 34 that also have the inlet 28 and the outlet 30, respectively, and that are connected to one another in a gas-tight manner—preferably welded. The housing parts 32, 34 each have an axial shoulder 36 by which the bearing mats 24 are pressed against the heating disk 10 and the carrier elements 18. The properties of the bearing mats 24 are such that, on the one hand, a thermal expansion of the heating disk 10 in the axial direction A can be absorbed and, on the other hand, mechanical vibrations/oscillations are damped. Not only the mechanical properties of the bearing mats 24 but also the strength of their pressing play a role in this respect.

In the embodiment in accordance with FIG. 4, the housing parts 32, 34 differ, in particular with regard to the design of the inlet 28 and the outlet 30, respectively. However, the inlet 28 and the outlet 30 can also be of a substantially identical design so that the housing parts 32, 34 are identical parts.

Since the carrier elements 18 are slightly thicker than the heating disk 10, the corresponding axial overhang 38 is pressed into the bearing mats 24 arranged at the inlet side, which increases the local pressing of the bearing mats 24 and ultimately also improves the fixing of the composite comprising the carrier elements 18 and the heating disk 10. The axial overhang 38 can, for example, be in an order of magnitude of 0.5 to 1 mm. In certain applications, an axial overhang 38 can also be omitted or is selected larger, if this is necessary.

An air gap 42 is provided between the outer periphery of the carrier elements 18 and of the bearing mats 24, on the one hand, and axial sections 40 of the housing parts 32, 34 in order to absorb an expansion of the composite comprising the heating disk 10 and the carrier elements 18 due to thermal effects.

Projections 44 that extend in the axial direction from the axial shoulders 36 secure the bearing mats 24 radially inwardly. In many cases, such a securing is not necessary so that the projections 44 can be omitted.

The heating disk 10 shown in FIGS. 5 to 7 corresponds to that of FIGS. 3 and 4. Instead of circular segment-shaped carrier elements, a carrier ring 18A is provided in the embodiment shown here. The carrier ring 18A has spacers 20 that extend in the axial direction from said carrier ring 18A and that project into the open ends of the gaps 16 of the heating disk 10 in the assembled state (see FIGS. 6 and 7). The carrier ring 18A covers a marginal region of the end face of the heating disk 10.

In FIG. 7, it can be seen that a ring-shaped bearing mat 24 has been applied to the carrier ring 18A. Such a mat 24 is also located at the oppositely disposed end face of the heating disk 10. At the peripheral side, the heating disk 10 is not surrounded by a section of the carrier ring 18A. An electrical insulation is nevertheless provided since the bearing mats 24 consist of an electrically insulating material and since an insulating air gap is provided in a suitable design of the housing parts 32, 34 (cf. embodiment in accordance with FIG. 4).

FIG. 8 shows a carrier ring 18B that has a contact surface 46 and from whose margin a peripheral wall 48 extends in the axial direction. The carrier ring 18B further has spacers 20 that likewise extend from the contact surface 46 in the axial direction and that are in connection with the peripheral wall 48. The peripheral wall 48 has connection recesses 50 for the connectors 12.

The heating disk 10 is encompassed at both sides by a respective carrier ring 18B, as can be seen in FIGS. 9 and 10. The carrier rings 18B are identical parts in this example, but can also have different designs if required. In an assembled state of the carrier rings 18B, their spacers 20 engage into the open ends of the gaps 16 of the heating disk 10. Furthermore, the heating disk 10 is engaged around at the peripheral side by the peripheral walls 48, whereby an insulation is provided.

FIG. 11 shows a heating device 26 in a sectional view in which the components described with reference to FIGS. 8, 9, and 10 have been installed. FIG. 12 shows a perspective view of the heating device 26 and FIG. 13 shows an exploded view of its components.

The heating disk 10 is encompassed at both sides by carrier rings 18B that are in turn each supported via bearing mats 24 at the housing parts 32, 34. An air gap 42 is provided radially outside the carrier rings 18B. The carrier rings 18B are spaced apart from one another at the end face (i.e. they do not contact one another at least in a cold state, see spacing 52) in order to compensate or offset component tolerances and/or thermal expansions and thus to ensure a secure support of the disk 10.

FIGS. 14 and 15 show a heating device 26 in a sectional view and in a perspective sectional view, respectively. Here, a carrier ring 18C is provided with a contact surface 46 for contact with an end face of the heating disk 10 from which spacers 20 extend in the axial direction into the open ends of the gaps 16 of the heating disk 10.

It can furthermore easily be seen that the spacers 20 project into the gaps 16 over only a part of the axial extent of the gaps 16. Furthermore, it can be seen that only the bearing mat 24, and no carrier element or carrier ring (even though this would generally be possible), is arranged between the inlet-side end face of the heating disk 10 and the corresponding axial shoulder 36. An electrical insulation between the heating disk 10 and the housing section 32 is nevertheless provided since the material of the bearing mats 24 has electrically insulating properties.

Alternatively, it is possible to configure the spacers 20 such that they extend completely through the gaps 16 in the axial direction or even project from the oppositely disposed end face of the heating disk 10.

FIGS. 16 and 17 show a part of an exhaust gas treatment device 54 having a heating device 26 in a sectional view and in a perspective view, respectively. The heating device 26 is held in a sheet metal housing 56 that also includes a catalytic converter 58 and/or a filter element. The catalytic converter 58 is reliably fixed in the housing 56 by at least one bearing mat 57 that is preferably a swelling mat.

Exhaust gas (arrow) flowing from the left into the sheet metal housing 56 is heated by the heating device 26 so that the catalytic converter 58 reaches its operating temperature as quickly as possible.

In the embodiment shown, the heating device 26 comprises the structure or composite already described with reference to FIGS. 8 to 13 comprising the heating disk 10, the carrier rings 18B, and the bearing mats 24. Differences, however, result in the construction of the housing parts 32A, 34A encompassing them. The housing component 34A is of a ring-shaped design and has an L shape in cross-section. The structure described above is inserted into the housing part 34A until it contacts the axial shoulder 36 of said housing part 34A. The housing part 32A, which is configured as a planar ring, is then inserted and is acted on by a suitable force so that the desired pressing of the bearing mats 24 is achieved. A fixing then takes place by a welding of the housing parts 32A, 34A (see weld seam 60).

The heating device 26 thus obtained is then inserted from the left into the sheet metal housing 56 until it contacts a shoulder 62 of the sheet metal housing 56. The fixing of the heating device 26 takes place by means of a further weld seam 60A.

FIGS. 18 and 19 show a part of an exhaust gas treatment device 54 with a heating device 26 in a sectional view and in a perspective view, respectively. This exhaust gas treatment device 54 is similar in large parts to that of FIGS. 18 and 19.

However, instead of the planar ring 32A, an L-shaped housing part 32B is used here. It can be inserted more easily into the housing part 34A since its section extending in the axial direction acts as a guide.

The heating device 26 in accordance with FIG. 20 differs from the heating device 26 in accordance with FIG. 18 in that, instead of two separate bearing mats 24, a bearing mat 24A having a U shape in cross-section and completely engaging around the marginal region of the heating disk 10 is used. The heating device 26 can also consist of a plurality of separate circular segments.

A pressing of the bearing mat 24A during the assembly of the heating device 26 only or at least mainly takes place in the axial direction. Between the housing part 34A and the carrier rings 18B, the bearing mat 24A is not pressed or is only slightly pressed in a cold state of the heating device 26 so that a thermal expansion of the components can be absorbed. Under certain circumstances, an air gap can also additionally be provided here.

FIG. 21 shows a variant of the housing parts 32B′ and 34A′ that are L-shaped identical parts and that are welded to one another at the end face of their axial sections. Like the other housing part concepts described here, said housing parts 32B′ and 34A′ can generally receive any desired structure of a package comprising the heating disk, the carrier element(s)/carrier ring(s), and the bearing mat(s).

In the heating device 26 in accordance with FIG. 22, a bearing mat 24, which is configured as a planar ring, and a bearing mat 24B are used. The bearing mat 24B has an L shape in cross-section and can be provided as a molded part. A radial clearance can also be provided in this design when the mats 24, 24B are indeed not acted on by forces, or are only acted on by moderate forces, in the radial direction during the assembly. An air gap can likewise be present.

FIG. 23 illustrates that carrier elements 18D having a U-shaped cross-section can also be used. They would then advantageously have to be configured as separate circular segments, similarly to the carrier elements 18 that are shown in FIGS. 1 to 4. In other words, the carrier elements 18D are not closed in the peripheral direction, on the one hand, to enable an assembly and, on the other hand, to enable a thermal expansion of the heating disk 10. The carrier elements 18D can optionally be formed as identical parts and/or can be arranged spaced apart in the peripheral direction.

FIG. 24 shows a part of an exhaust gas treatment device 54 in a sectional view. The exhaust gas treatment device 54 comprises a catalytic converter 58 that is axially fixedly held in a sheet metal housing 56 by means of the bearing mat 57. The inlet-side end of the sheet metal housing 56 is inserted into the outlet 30 of the housing part 34 and is connected thereto in a gas-tight manner. The structure comprising the heating disk 10, the carrier rings 18B, and the bearing mats 24 substantially corresponds to the structure in accordance with FIGS. 8 to 13. The housing part 32 is a cast part that simultaneously forms an inlet funnel of the exhaust gas treatment device 54. A gas-conducting inner tube 64 is arranged in the inlet funnel and supplies exhaust gas of an internal combustion engine to the heating device 26 (see the arrow). Between the inner tube 64 and the housing part 32, a heat-insulating air gap 42 A is present that minimizes heat losses and that thus likewise contributes to a faster heating of the catalytic converter 58.

FIG. 25 shows a heating disk 10, which is encompassed by two housing parts 32, 34 of identical design, in a perspective view. A side view can be seen in FIG. 27. Details of the design of the carrier device and/or of the bearing mats are not looked at in this connection. They can be designed or arranged in accordance with one of the embodiments described above.

As can in particular be seen from FIG. 26, the housing parts 32, 34 each have a ring section 68, which extends substantially in a plane in parallel with the heating disk 10 and which covers a radially outer ring region of the disk 10, and a plurality of—in the present example—tabs 70 that extend from the ring section 68 in the axial direction. Cutouts 72 having, in the present example, two different dimensions are disposed between the tabs 70. Two mutually oppositely disposed cutouts 72 are slightly wider than the four other cutouts 72, for example, to be able to receive two connectors 12 (see FIG. 38). However, it is also possible to make all cutouts 72 the same.

During the assembly, the housing parts 32, 34 are laterally applied to the heating disk 10, which is provided with the carrier device and, if necessary, with one or more bearing mats, until the end faces of mutually oppositely disposed tabs 70 are in contact with one another. Then, the tabs 70 are connected to one another, in particular welded. The axial extent of the tabs 70, which can also have different axial lengths, defines the spacing which the ring sections 68 have from one another in an assembled state. This spacing, in turn, defines how strongly the components encompassed by the housing parts 32, 34 are held. In this connection, one speaks of a path-controlled assembly or also of an assembly “on blockage”.

The state shown in FIGS. 25 and 27 is a pre-assembly state (package P1). The heating disk 10 is securely held and can now be fed to further assembly steps.

FIG. 28 shows housing shells 74, 76 that receive the pre-assembled package P1 shown in FIGS. 25 and 27. In FIG. 29, the package P1 has been inserted into the housing shell 74. With the placement of the complementary housing shell 76 and the connection of the shells 74, 76 and a fastening of the package P1 to the shells 74 and/or 76, a further pre-assembly state is achieved in which the heating disk 10 is already well protected and securely held (package P2). In this state, the package P2 can now be integrated into an exhaust gas system. This is also possible in the state described further above if the exhaust gas system has components that are suitably configured for receiving the P1.

The connection of the shells 74, 76 can, for example, take place by welding or another process. A connection between the housing shells 74 and/or 76, on the one hand, and the housing parts 32 and/or 34, on the other hand, can likewise take place by welding. For example, the shells 74, 76 are sectionally connected to the ring sections 68. This is possible without further ado since corresponding contact regions are accessible from the end faces. Additionally or alternatively, it is also possible to provide radial openings (not shown), for example elongated holes, in the housing shells 74, 76, through which radial openings a welding of the shells 74, 76 to the tabs 70 is made possible.

The embodiment shown in FIGS. 31 to 34 substantially corresponds to that shown in FIGS. 25, 27 and 29 to 30. The shells 74 and 76 can be of a similar or identical design. One significant difference, however, is that the housing parts 32, 34 are not identical parts. They have differently designed tabs 70A, 70B, which has the result that the cutouts 72A, 72B also differ from one another. Furthermore, the tabs 70A, 70B are not “on blockage”. Rather, the tabs 70B are plugged into the tabs 70A. Alternatively to a purely force-fitting plug-in connection, a bonded connection (e.g. a weld connection) or a form-fitting connection (e.g. by means of latch elements) can be provided. Combinations of the connection types mentioned above are likewise conceivable.

In the design described above, the tabs 70A, 70B do not necessarily provide a limitation of the assembly movement. It would indeed be possible to provide abutment elements that achieve this in a well-defined manner. However, in the assembly in the embodiment in accordance with FIGS. 31 to 34, a force-controlled approach is used. In other words, during the assembly, the force applied in the axial direction in this respect is monitored so that a compression of the components encompassed by the housing parts 32, 34 does not exceed a predetermined threshold value. If bearing mats are used, they are thus intentionally compressed to generate the desired holding force.

FIG. 35 shows a slightly modified variant of the embodiment in accordance with FIGS. 31 to 34 in which the tabs 70C of the housing parts 32, 34 are of approximately equal length in the peripheral direction and are arranged distributed in the same manner in the peripheral direction. The tabs 70C of the housing parts 32, 34 are alternately plugged into one another, i.e. in the case of a tab pair, the tab 70C of the housing part 32 is e.g. plugged into the tab 70C of the housing part 34, while in the case of the adjacent tab pairs, the tab 70C of the housing part 32 is plugged onto the tab 70C of the housing part 34. In this variant, the stamped parts underlying the housing parts 32, 34 can be identical parts.

FIGS. 36 and 37 show sections through embodiments with housing parts having tabs 70 that are arranged end-to-end or having overlapping tabs 70A, 70B, or 70C. The structure of the components held by the housing parts 32, 34 is only shown by way of example. Alternative embodiments of this structure are conceivable. A connection between the housing shells 74 and/or 76, on the one hand, and the housing parts 32 and/or 34, on the other hand, is not shown.

With reference to FIGS. 38 to 41, it is made clear that the cutouts 72 between the tabs 70 permit the connectors 12 of the heating disk 10 to be positioned as required without the housing parts 32, 34 having to be changed.

In FIGS. 42 to 45, different embodiments of compact carrier elements 18E are shown that are combined with one another to prevent a short circuit of the heating disk 10 and to ensure its electrical insulation.

The carrier elements 18E in accordance with FIG. 42 comprise a spacer section 78 that passes through an extended end section of the respective gap 16 and that connects end face sections 80 disposed on both end faces of the heating disk 10. The end face sections 80 cover a (small) section of a marginal region of the heating disk 10.

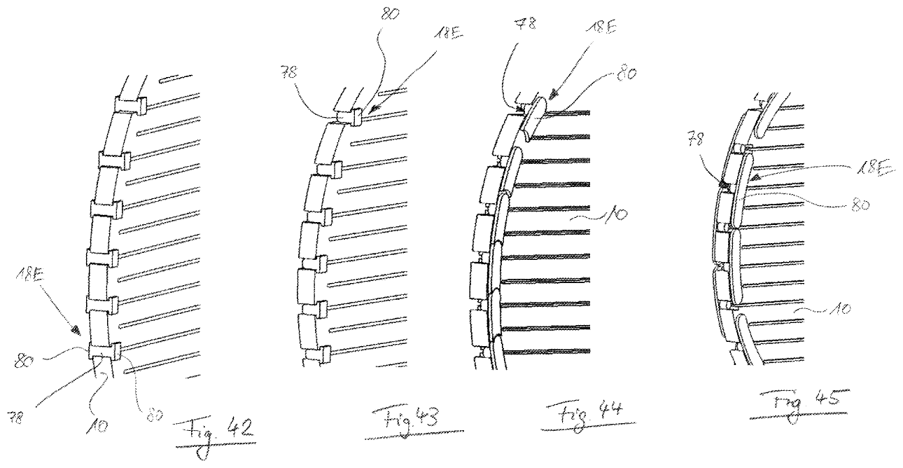

The carrier elements 18E in accordance with FIG. 43 each have a shorter spacer section 78 that does not completely pass through the extended end section of the respective gap 16. Therefore, the spacer section 78 is only connected to one end face section 80. In deviation from the embodiment shown, the elements 18E can be inserted into said end face sections in a regular or irregular alternating manner from both end faces of the heating disk 10 (see also FIG. 45).

The carrier elements 18E in accordance with FIG. 44 have an even shorter spacer section 78 compared to the embodiment in accordance with FIG. 43. However, the respective end face section 80 is longer in the peripheral direction of the heating disk 10 so that the radially outer marginal region of the heating disk 10 is covered for the most part. The spacer section 78 is not centrally arranged with respect to the end face section 80. It can further be seen that it is not absolutely necessary for the end face sections 80 of adjacent elements 18E to contact one another in order to achieve an end face insulation of the heating disk 10. In this embodiment, the elements 18E can be plugged into the same end section of the respective gap 16 from both sides since their spacer section 78 has an extent in the axial direction that amounts to less than half the thickness of the heating disk 10. An alternating arrangement of the elements 18E is also conceivable (see also FIG. 45).

The carrier elements 18E in accordance with FIG. 45 each have a spacer section 78 that is substantially similar to that of the carrier elements 18E in accordance with FIG. 44. However, the spacer section 78 is centrally arranged with respect to the end face section 80. Due to an alternating arrangement of the carrier elements 18E, which are alternately inserted from both end faces of the heating disk 10, the marginal region of the heating disk 10 is covered for the most part.

It is understood that individual features that have been explained in more detail with reference to specific embodiments can also be transferred to other embodiments, if necessary, to be able to take optimum account of the requirements present in each case.

The concept in accordance with the invention was indeed described above with respect to the exhaust gas technology of an internal combustion engine. However, it can also be applied in other areas in which a heating of a gas flow is required.

### REFERENCE NUMERAL LIST

10 heating disk

12 connector

14 heating segment

16 gap

18, 18D, 18E carrier element

18A, 18B, 18C carrier ring

20 spacer

24, 24A, 24B bearing mat

26 heating device

28 inlet

30 outlet

32, 32A, 32B, 32B′

34, 34A, 34A′ housing part

36 axial shoulder

38 axial overhang

40 axial section

42, 42A air gap

44 projection

46 contact surface

48 peripheral wall

50 connection recess

52 spacing

54 exhaust gas treatment device

56 sheet metal housing

57 bearing mat

58 catalytic converter

60, 60A weld seam

62 shoulder

64 inner tube

68 ring section

70, 70A, 70B, 70C tab

72, 72A, 72B cutout

74, 76 housing shells

78 spacer section

80 end face section

A axial direction

P1, P2 package

1-29. (canceled)

30. A heating device for heating a gas flow, said heating device comprising
an electrically conductive heating element that can be flowed through by the gas flow in an axial direction and that has at least two heating segments that are sectionally separated from one another by a gap;
a carrier device having at least one electrically insulating carrier element that at least sectionally surrounds the heating element in a peripheral direction and/or at least sectionally covers a marginal region of at least one axial end face of the heating element,
wherein the carrier element has at least one spacer section that projects into the gap; and
a housing section in which the heating element and the carrier device are held.

31. The heating device in accordance with claim 30,
wherein the spacer section extends in the axial direction and/or in a direction perpendicular to the axial direction from the carrier element into the gap.

32. The heating device in accordance with claim 30,
wherein the carrier element is of a ring-like design or has a basic shape of a circular segment.

33. The heating device in accordance with claim 30,
wherein the carrier device is formed in multiple pieces.

34. The heating device in accordance with claim 33,
wherein the carrier device comprises a first carrier element and a second carrier element that each surround at least a part of the periphery of the heating element and/or that each cover at least a part of a marginal region of at least one end face of the heating element.

35. The heating device in accordance with claim 33,
wherein the first carrier element and the second carrier element are identical parts.

36. The heating device in accordance with claim 30,
wherein the heating element is supported at the housing section via a bearing mat.

37. The heating device in accordance with claim 30,
wherein the carrier device is supported at the housing section via a bearing mat.

38. The heating device in accordance with claim 30,
wherein a clearance exists between the carrier device and/or the heating element, on the one hand, and the housing section, on the other hand, in a radial direction at least in a cold state of the heating element.

39. The heating device in accordance with claim 30,
wherein the heating element has a honeycomb basic structure.

40. The heating device in accordance with claim 30,
wherein the heating element has a plurality of gaps.

41. The heating device in accordance with claim 30,
wherein the housing section has at least one axial shoulder at which the heating element is supported in the axial direction.

42. The heating device in accordance with claim 30,
wherein the housing section is formed in multiple parts.

43. The heating device in accordance with claim 42,
wherein the housing section comprises a first housing element and a second housing element between which the carrier device is held with the heating element.

44. The heating device in accordance with claim 43,
wherein the first housing element and/or the second housing element and/or the carrier device and/or the first carrier element and/or the second carrier element are L-shaped in a cross-section.

45. The heating device in accordance with claim 43,
wherein the first housing element and/or the second housing element has/have a connection section by means of which the housing section can be connected to further gas-conducting components.

46. The heating device in accordance with claim 43,
wherein the first housing element is plugged into the second housing element.

47. The heating device in accordance with claim 43,
wherein the first housing element and/or the second housing element is/are sheet metal components.

48. The heating device in accordance with claim 43,
wherein the first housing element and/or the second housing element comprises/comprise a ring section having at least one tab section extending in the axial direction.

49. The heating device in accordance with claim 43,
wherein the first housing element and/or the second housing element component is/are cast parts.

50. The heating device in accordance with claim 30,
wherein the housing section has a first and a second contact opening through which the heating element is electrically contactable.

51. The heating device in accordance with claim 30,
wherein the housing section is held by an outer housing that surrounds the housing section in the radial direction.

52. The heating device in accordance with claim 51,
wherein the outer housing comprises a first outer housing element and a second outer housing element.

53. The heating device in accordance with claim 30,
wherein the carrier element is at least sectionally produced from corundum and/or an electrically insulating ceramic material.

54. An exhaust gas treatment device comprising an inlet and an outlet and at least one exhaust gas treatment unit for treating an exhaust gas flow, wherein a heating device is arranged between the inlet and the exhaust gas treatment unit, wherein the heating device comprises
an electrically conductive heating element that can be flowed through by the gas flow in an axial direction and that has at least two heating segments that are sectionally separated from one another by a gap;
a carrier device having at least one electrically insulating carrier element that at least sectionally surrounds the heating element in a peripheral direction and/or at least sectionally covers a marginal region of at least one axial end face of the heating element, wherein the carrier element has at least one spacer section that projects into the gap; and
a housing section in which the heating element and the carrier device are held.

55. The exhaust gas treatment device in accordance with claim 54,
wherein a single-piece housing component is provided that receives the exhaust gas treatment unit and the heating device.

56. The exhaust gas treatment device in accordance with claim 55,
wherein the housing section of the heating device forms a part of a housing of the exhaust gas treatment device.

57. The exhaust gas treatment device in accordance with claim 54,
wherein the housing section is held by an outer housing that surrounds the housing section in the radial direction, wherein the outer housing has an inlet connection section for connecting the heating device to a tube section of an exhaust gas system that forms the inlet, and wherein the outer housing has an outlet connection section that is connected to a housing component receiving the exhaust gas treatment unit.

58. An exhaust gas system of an internal combustion engine comprising an exhaust gas treatment device, wherein the exhaust gas treatment device comprising an inlet and an outlet and at least one exhaust gas treatment unit for treating an exhaust gas flow, wherein a heating device is arranged between the inlet and the exhaust gas treatment unit, wherein the heating device comprises
an electrically conductive heating element that can be flowed through by the gas flow in an axial direction and that has at least two heating segments that are sectionally separated from one another by a gap;
a carrier device having at least one electrically insulating carrier element that at least sectionally surrounds the heating element in a peripheral direction and/or at least sectionally covers a marginal region of at least one axial end face of the heating element, wherein the carrier element has at least one spacer section that projects into the gap; and
a housing section in which the heating element and the carrier device are held.

59. The heating device in accordance with claim 30, wherein the gap is open at one side.
